(19) United States
(12) Patent Application Publication
(10) Pub. No.: US 2023/0331239 A1
(43) Pub. Date: Oct. 19, 2023

(54) METHOD, APPARATUS AND VEHICLE FOR ADAPTIVELY EVALUATING A DRIVER'S PERFORMANCE IN SAFE DRIVING

(71) Applicant: NEC Corporation, Minato-ku, Tokyo (JP)

(72) Inventors: Yew Chong Raymond LEONG, Singapore (SG); WEIJIAN TAN, Singapore (SG); Xiaoshan ZHONG, Singapore (SG); Pujianto Christopher CHIAM, Singapore (SG); Andeline Hui Lin CHONG, Singapore (SG)

(73) Assignee: NEC Corporation, Minato-ku, Tokyo (JP)

(21) Appl. No.: 18/025,616

(22) PCT Filed: Aug. 19, 2021
(86) PCT No.: PCT/JP2021/030478

§ 371 Date: Mar. 9, 2023

(30) Foreign Application Priority Data
Sep. 17, 2020 (SG) 10202009149Q

(51) Int. Cl. B60W 40/09

(52) U.S. Cl. CPC B60W 40/09; B60W 2556/10

(57) ABSTRACT

The present disclosure provides a method, a device and a vehicle for adaptively evaluating a driver’s performance in safe driving. The method comprising: receiving data relating to at least one risk variable which relates to the driver at a time point; retrieving historical data relating to the at least one risk variable; determining if the driver’s performance in safe driving improves based on the historical data and the data; and determining the optimal period to evaluate the driver’s performance in safe driving in response to determining if the driver’s performance in safe driving improves.

### TECHNICAL FIELD

The present disclosure relates broadly, but not exclusively, to a method and a device for adaptively evaluating a driver’s performance in safe driving.

### BACKGROUND ART

National Safety Council reports that 94 percent of deadly car crashes are caused by some type of human error. Unless and until there are fully autonomous cars that drive themselves, the mistakes that people make will continue to cause thousands of deaths in auto accidents every year.

### SUMMARY OF INVENTION

### Technical Problem

Existing solution involves sensor-based telematics device to understand driving behavior, states of driver & vehicles, and other risk variables to assess the accident risk of drivers. To mitigate accident risk, such solutions take a step further to reveal what each drivers fail to perform well, in other words what to improve. For example, a recommendation to control speed and acceleration.

Such information is useful to insurance companies. It leads to the creation of new motor insurance model like Pay-How-You-Drive (PHYD) and Manage-How-You-Drive (MHYD). PHYD offering lower premium to safe drivers, and MHYD take a step further in actively engage drivers to manage driving risk.

Such information is useful to businesses with a fleet. They developed programs to educate safe driving and at times enforce discipline. It helps in mitigating business risk and contributing to corporate social responsibility.

Although various assessment tools have been devised, these can be of limited use in the assessment of a driver’s performance in safe driving before the business ascertain risk is lowered.

Without this critical information, business prematurely lift their invention effort, and insurance companies may be offering lower premium to drivers who do not exercise or perform safe driving, in other words drivers who merely exhibit short term safe driving practice.

Therefore, reliable assessment is needed in business and community setting.

Herein disclosed are embodiments of a device and methods for providing objective driver’s safety assessment that addresses one or more of the above problems.

Furthermore, other desirable features and characteristics will become apparent from the subsequent detailed description and the appended claims, taken in conjunction with the accompanying drawings and this background of the disclosure.

### Solution to Problem

In a first aspect, the present disclosure provides a method for adaptively deriving an optimal period to evaluate a driver’s performance in safe driving, comprising: receiving data relating to at least one risk variable which relates to the driver at a time point; retrieving historical data relating to the at least one risk variable; determining if the driver’s performance in safe driving improves based on the historical data and the data; and determining the optimal period to evaluate the driver’s performance in safe driving in response to determining if the driver’s performance in safe driving improves.

In a second aspect, the present disclosure provides an apparatus for adaptively deriving an optimal period to evaluate a driver’s performance in safe driving, the apparatus comprising: at least one processor; and at least one memory including computer program code; the at least one memory and the computer program configured to, with at least one processor, cause the apparatus at least to: receive data relating to at least one risk variable relating to the driver at a time point; retrieve historical data relating to the at least risk variable; determine if the driver’s performance in safe driving improves based on the historical data and the data; and determine the optimal period to evaluate the driver’s performance in safe driving in response to determining if the driver’s performance in safe driving improves.

In a third aspect, the present disclosure provides a vehicle for adaptively evaluating a driver’s performance in safe driving, comprising the apparatus according to the second aspect.

### Advantageous Effects of Invention

The above aspects can contribute to solve the above problem.

### BRIEF DESCRIPTION OF DRAWINGS

The accompanying Figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention will be better understood and readily apparent to one of ordinary skill in the art from the following written description, by way of example only, and in conjunction with the drawings, in which:

FIG. 1 shows a system to adaptively evaluate a driver’s performance in safe driving according to an aspect of the present disclosure.

FIG. 2 shows how an optimal period to evaluate a driver’s performance in safe driving is adaptively derived according to an embodiment of the present disclosure.

FIG. 3A shows how an optimal period to evaluate a driver’s performance in safe driving is adaptively derived according to an embodiment of the present disclosure.

FIG. 3B shows how an optimal period to evaluate a driver’s performance in safe driving is adaptively derived according to an embodiment of the present disclosure.

FIG. 3C shows how an optimal period to evaluate a driver’s performance in safe driving is adaptively derived according to an embodiment of the present disclosure.

FIG. 4 depicts a flow chart illustrating a process of adaptively deriving an optimal period to evaluate a driver’s performance in safe driving according to embodiments of the present disclosure.

FIG. 5A shows a flow chart illustrating a process of adaptively deriving an optimal period to evaluate a driver’s performance in safe driving according to embodiments of the present disclosure.

FIG. 5B shows a flow chart illustrating a process of adaptively deriving an optimal period to evaluate a driver’s performance in safe driving according to embodiments of the present disclosure.

FIG. 6 shows graphical user interface examples of how a program running an application for adaptively deriving an optimal period to evaluate a driver’s performance in safe driving from on-boarding to completion of the program according to an embodiment of the present disclosure.

FIG. 7A shows other graphical user interface examples of how a program running an application for adaptively deriving an optimal period to evaluate a driver’s performance in safe driving from on-boarding to completion of the program according to an embodiment of the present disclosure.

FIG. 7B shows other graphical user interface examples of how a program running an application for adaptively deriving an optimal period to evaluate a driver’s performance in safe driving from on-boarding to completion of the program according to an embodiment of the present disclosure.

FIG. 8 depicts another graphical user interface example of how a program running an application for adaptively deriving an optimal period to evaluate a driver’s performance in safe driving from on-boarding to completion of the program according to an embodiment of the present disclosure.

FIG. 9 depicts yet another graphical user interface example of how a program running an application for adaptively deriving an optimal period to evaluate a driver’s performance in safe driving and showing result of derivation according to an embodiment of the present disclosure.

FIG. 10 shows an exemplary computing device that may be used to execute the method of FIG. 5A and FIG. 5B.

### DESCRIPTION OF EMBODIMENTS

### Terms Description

Subject - a subject may be any suitable type of entity, which may include a person, a driver and a user. The term subject is used herein to identify a user or driver that requires safety of a driver to be assessed. A subject who is registered to a drivers’ safety assessment server will be called a registered user. A user who is not registered to the safety assessment will be called a non-registered user. The term subject will be used to collectively refer to both registered and non-registered users. The term driver may also be used to refer to both registered and non-registered users.

Drivers’ Safety Assessment Server - The drivers’ safety assessment server is a server that hosts software application programs for receiving inputs, processing data and adaptively deriving an optimal period to evaluate a driver’s performance in safe driving. The drivers’ safe driving evaluation period derivation server communicates with any other servers (e.g., a remote assistance server) to manage requests and monitor a driver’s performance in safe driving. The drivers’ safety assessment server communicates with a remote assistance server to derive an optimal period to evaluate a driver’s performance in safe driving and facilitate situations in which programs need to be managed to assist a driver to be a better driver over the optimal period. Drivers’ safety assessment server may use a variety of different protocols and procedures in order to manage the data and derive an optimal period to evaluate a driver’s performance in safe driving.

The drivers’ safety assessment server is usually managed by a provider that may be an entity (e.g. a company or organization) which operates to process requests, manage safety programs by determining a score relating a driver’s performance in safe driving and a target improvement of the driver and how to assist the driver to achieve the target improvement. The server may include one or more computing devices that are used for processing performance score requests and providing services beyond typical assessment.

A driver’s safety assessment account - a driver’s safety assessment account is an account of a user who is registered at a drivers’ safety assessment server. In certain circumstances, the driver’s safety account is not required to use the remote assistance server. A driver’s safety assessment account includes details (e.g., name, address, vehicle etc.) of a user and track details of a program that he is on.

The driver’s safety assessment server manages driver’s safety assessment accounts of users and the interactions between users and other external servers, along with the data that is exchanged.

Optimal period is a parameter that is used to evaluate a driver’s performance in safe driving. In some embodiments, the optimal period may refer to a time period and/or a distance in which a driver’s performance in safe driving is evaluated. An optimal period for a driver (user) is determined based on how the driver’s performance in safe driving improves over time and/or distance, and different optimal periods may be determined for different drivers (users) depending on the respective performances and improvements in their performances in safe driving. In various embodiments, an optimal period is an estimated time period and/or an estimated distance for the driver to achieve a desired (target) performance in safe driving and become a better driver based on the driver’s performance history and an estimation of his capabilities to improve his driving performance to the desired performance. For example, one driver who has a better performance in safe driving may have shorter optimal period to evaluate the driver’s performance. In various embodiments below, an optimal period is related to a time period by way of example only and is not intended to be limiting. Notably, an optimal time period can be interpreted as an optimal travelled distance to evaluate a driver’s performance in safe driving, therefore and can be used interchangeably throughout the present disclosure.

A risk variable is a parameter that is used to evaluate a driver’s performance in safe driving at a time point or over a time period. Examples of a risk variable are count of speeding, count of swaying, count of sharp cornering, count of harsh acceleration, count of harsh braking per kilometre driven, distance per day driven and duration per day driven, count of driving complaints, count of customer service complaints and count of fault accidents. In an embodiment, when a driver travels in a journey from destination A to destination B at current time point, data relating to a risk variable(s) may be measured and used to determine a driver’s performance in safe driving in entire or part of the journey at the current time point, and determine if the driver’s performance in safe driving improves by comparing against historical data measured in one or more driver’s previous journeys or at one or more previous time points. In another embodiment, even when the driver does not make a trip at current time point, data relating to a risk variable(s) measured over a time period in the past, e.g. for the last few days, weeks or months, may be retrieved and used to determine a driver’s performance in safe driving over the time period, and determine if the driver’s performance in safe driving improves by comparing against the driver performance at a time point or over another time period.

Historical data refers to data that were previously received and used to determine a driver’s performance in safe driving at a previous time point prior to a current time point, and are now retrieved to compared against data that are currently received at the current time point to determine if a driver’s performance has improved. In various embodiments below, examples of historical data can be all data that were received since a beginning of time, since a time point when a driver’s license was renewed, or data that were received in recent months, weeks or days, or data that were received in a number of most recent trips (e.g. 5 trips or 10 trips) made by the driver.

A score refers to as a safety score which quantifies an overall performance of a driver in safe driving over a time period or a travelled distance, for example a time period between a previous time point at which the retrieved historical data was first received to a current time point. In various embodiments, data and historical data relating to a risk variable obtained within the time period may be received and/or retrieved to determine and calculate the score. A desired score indicates the driver has, in overall, achieved a desired performance safe driving during the time period, i.e. from the previous time point (start of time period) to the current time point (end of time period). In the present disclosure, as illustrated in the specific embodiments below, a desired score is defined to refer to a score that is closer towards a higher end of a scale of score. In other words, the higher the score of a driver, the better the driver’s performance in safe driving, and a driver who achieves a performance better than the desired performance will have a score better (higher) than the desired score. It should be understood that a desired score may correspond to a score that is closer towards a higher end or a lower end of a scale of score depending on various implementations and alterations of the embodiments.

A preceding score refers to as a previous safety score that was determined using data (historical data) and used to quantifies a performance of a driver in safe driving over a time period in the past, for example a time period between two previous time points.

A target value is a target score that relates to a target improvement of a driver’s performance in safe driving set to be achieved by the driver. When the driver has a score that is close to or better than the target value, it is determined that the driver’s performance in safe driving has improved. In various embodiments, a target value to be achieved by a driver may be calculated based on an average score among average drivers whose performance in safe driving has been evaluated. If the driver achieves a score close to or better than the average score, it is determined that the driver’s performance in safe driving has improved and in line with the performances of the average drivers who practice safe driving. Alternatively or additionally, the target value to be achieved by a driver may be determined based on a preceding score of the driver which was used to determine the driver’s performance in safe driving over a time period in the past. The target value is set to be higher than the preceding score, and if the driver achieves a score that is close to or better than the target value, it is determined that the driver meets a target improvement of his/her score (current performance in safe driving) up from the preceding score (past performance in safe driving), which in turn determined that the driver the driver’s performance in safe driving has improved.

### Detailed Description

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

### The System 100

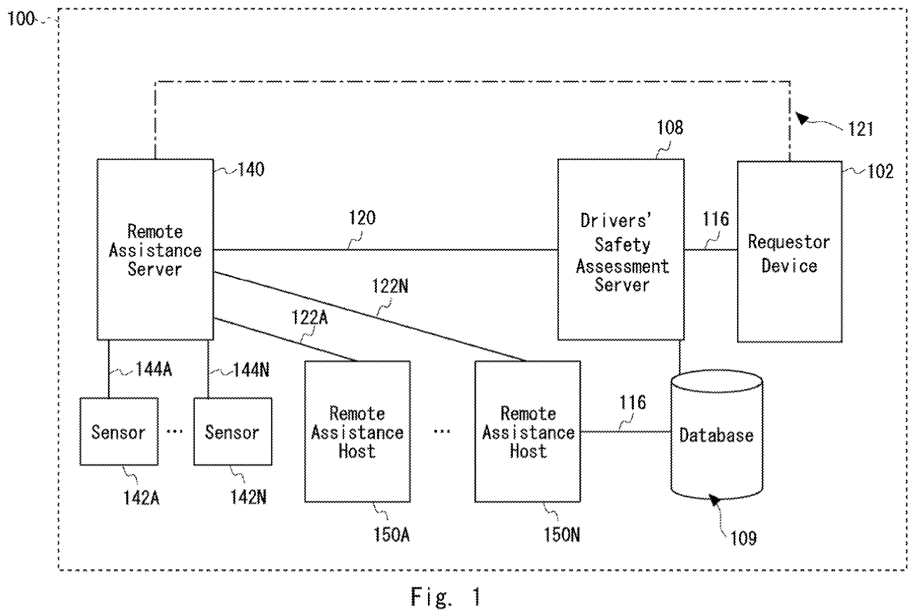

FIG. 1 illustrates a block diagram of a system 100 for adaptively evaluating a driver’s safety.

The system 100 comprises a requestor device 102, a driver’s safety assessment server 108, a remote assistance server 140, remote assistance hosts 150A to 150N, and sensors 142A to 142N.

The requestor device 102 is in communication with driver’s safety assessment server 108 and/or a remote assistance server 140 via a connection 116 and 21, respectively. The connection 116 and 121 may be wireless (e.g., via NFC communication, Bluetooth, etc.) or over a network (e.g., the Internet). The connection 116 and 121 may also be that of a network (e.g., the Internet).

The driver’s safety assessment server 108 is further in communication with the remote assistance server 140 via a connection 120. The connection 120 may be over a network (e.g., a local area network, a wide area network, the Internet, etc.). In one arrangement, the driver’s safety assessment server 108 and the remote assistance server 140 are combined and the connection 120 may be an interconnected bus.

The remote assistance server 140, in turn, is in communication with the remote assistance hosts 150A to 150N via respective connections 122A to 122N. The connections 122A to 122N may be a network (e.g., the Internet).

The remote assistance hosts 150A to 150N are servers. The term host is used herein to differentiate between the remote assistance hosts 150A to 150N and the remote assistance server 140. The remote assistance hosts 150A to 150N are collectively referred to herein as the remote assistance hosts 150, while the remote assistance host 150 refers to one of the remote assistance hosts 150. The remote assistance hosts 150 may be combined with the remote assistance server 140. In an example, the remote assistance host 150 may be one managed by a hospital and the remote assistance server 140 is a central server that manages data from each of the remote assistance hosts and decides which of the remote assistance hosts 150 to forward an emergency call.

Sensors 142A to 142N are connected to the remote assistance server 140 or the drivers’ safety assessment server 108 via respective connections 144A to 144N. The sensors 142A to 142N are collectively referred to herein as the sensors 142, while the sensor 142 refers to one of the sensors 142. The connections 144A to 144N are collectively referred to herein as the connections 144, while the connection 144 refers to one of the connections 144. The connection 144 may be wireless (e.g., via NFC communication, Bluetooth, etc.) or over a network (e.g., the Internet). The sensor 144 may be one of an image capturing device, motion sensor and an EMG sensor and may be configured to send a signal, depending on the type of sensor, to at least one of the requestor device 102.

In the illustrative embodiment, each of the devices 102 and142; and the servers 108, 140, and 150 provides an interface to enable communication with other connected devices 102 and 142 and/or servers 108, 140, and 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for the requestor device 102 to send an alert signal when a user presses a panic button on the GUI, while doing an exercise. Similarly, it is possible to make a request to obtain a safety score using the requester device 102.

Use of the term ‘server’ herein can mean a single computing device or a plurality of interconnected computing devices which operate together to perform a particular function. That is, the server may be contained within a single hardware unit or be distributed among several or many different hardware units.

### The Remote Assistance Server 140

The remote assistance server 140 is associated with an entity (e.g. a company or organization or moderator of the service). In one arrangement, the remote assistance server 140 is owned and operated by the entity operating the server 108. In such an arrangement, the remote assistance server 140 may be implemented as a part (e.g., a computer program module, a computing device, etc.) of server 108.

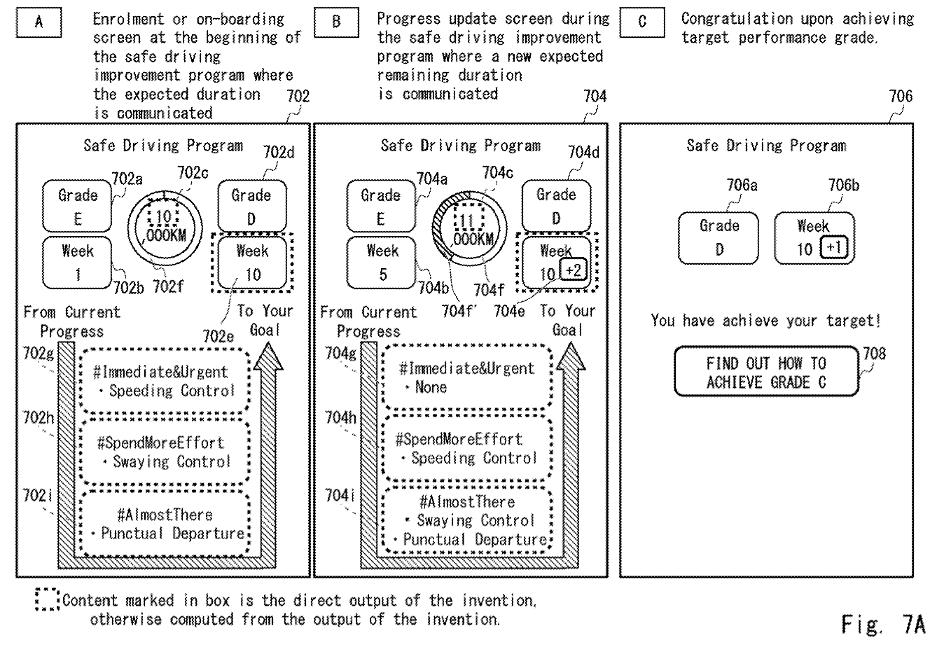

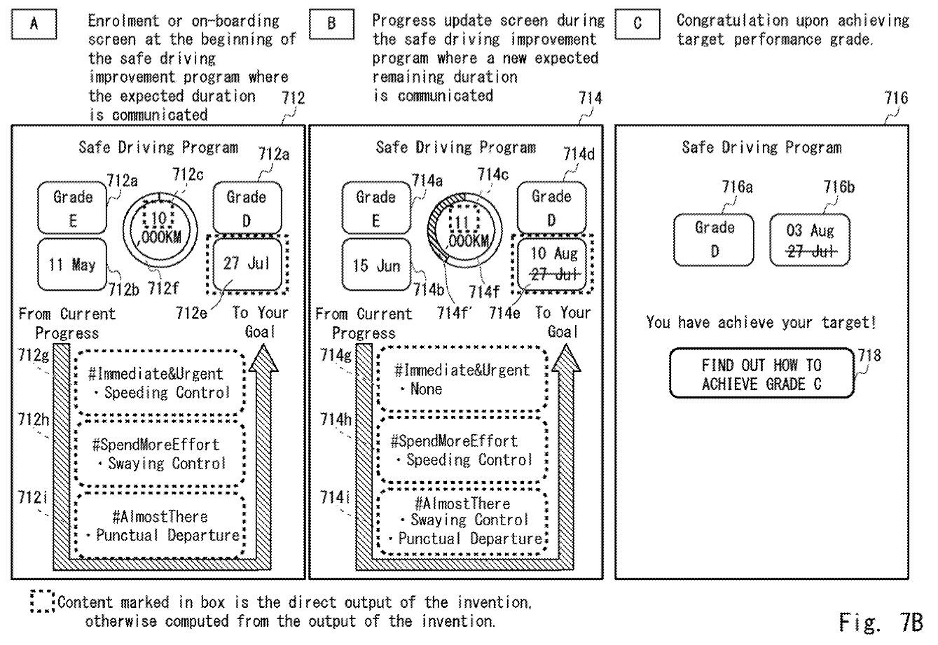

The remote assistance server 140 is also configured to manage the registration of users. A registered user has a remote access account (see the discussion above) which includes details of the user. The registration step is called on-boarding. A user may use either the requestor device 102 to perform on-boarding to the drivers’ safety assessment server. More details will be provided in FIG. 7.

It is not necessary to have a remote assistance account at the remote assistance server 140 to access the functionalities of the remote assistance server 140. That is, in some embodiments, the drivers’ safety assessment server may perform the functionalities of a remote assistance server 140. However, there are functions that are available to a registered user. For example, it may be possible to select a suitable workout program for a user based on clinical assessment. These additional functions will be discussed below.

The on-boarding process for a user is performed by the user through one of the requestor device 102. In one arrangement, the user downloads an app (which includes the API to interact with the remote assistance server 140) to the sensor 142. In another arrangement, the user accesses a website (which includes the API to interact with the remote assistance server 140) on the requestor device 102 or the provider device 104. The user is then able to interact with the remote assistance server 140 to via the sensor that is paired with the user.

Details of the registration include, for example, name of the user, address of the user, emergency contact, driver licence and other traffic accident information and the sensor 142 that is authorized to update the remote assistance account, and the like.

Once on-boarded, the user would have a remote assistance account that stores all the details.

### The Requestor Device 102

The requestor device 102 is associated with a subject (or requestor) who is a party to a safety score request that starts at the requestor device 102. The requestor may be an insurance worker who is assisting to get data necessary to obtain a safety score of a driver. The requestor may also be the driver himself. The requestor device 102 may be a computing device such as a desktop computer, an interactive voice response (IVR) system, a smartphone, a laptop computer, a personal digital assistant computer (PDA), a mobile computer, a tablet computer, and the like.

In one example arrangement, the requestor device 102 is a computing device in a watch or similar wearable and is fitted with a wireless communications interface.

The drivers’ safety assessment server 108 is as described above in the terms description section.

The drivers’ safety assessment server 108 is configured to process processes relating to adaptively evaluate a drivers’ safety assessment.

### The Remote Access Hosts 150

The remote access host 150 is a server associated with an entity (e.g. a company or organization) which manages (e.g. establishes, administers) resources relating to a driver.

In one arrangement, the entity is a central safety manager. Therefore, each entity operates a remote access host 150 to manage the resources by that entity. In one arrangement, a remote access host 150 receives an alert signal that a subject is likely to have a low safety score. The remote access host 150 may be a vehicle telematics system, a driver monitoring system, or one that stores information relating to a driver or other operations.

In one arrangement, the drivers’ safety score can be automatically updated on the account associated with the driver. Advantageously, this allows other parties like an insurance company to know how the driver is doing by reviewing the relevant account.

### Sensor 142

The sensor 142 is associated with a user associated with the requestor device 102. More details of how the sensor may be utilised will be provided below.

In an embodiment, the sensor is one that can obtain vehicle telematics. In another example, the sensor is one that is configured to collect data of other risk variables.

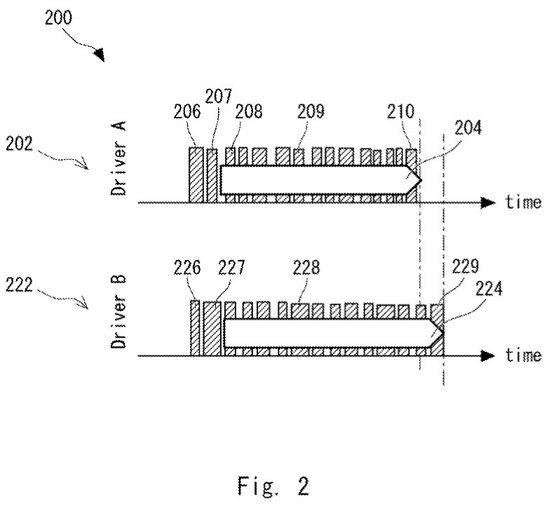

FIG. 2 shows how an optimal period to evaluate a driver’s performance in safe driving is adaptively derived according to an embodiment of the present disclosure. In this embodiment, Driver A 202 may make a first trip from location A to location B at a first time point, and one or more risk variables during the first trip may be measured. Data relating to the one or more risk variables, for example as indicated in block 206 may be received during the first trip and recorded. The Driver A 202 may subsequently make a second trip from location B to location C at a second time point, and one or more risk variables during the second trip may be measured. Data relating to the one or more risk variables at the second time point, for example as indicated in block 207, may be received during the first trip and recorded. In an embodiment, the one or more risk variables measured during the first trip and the second trip and the corresponding data 206 and 207 recorded may not be the same.

In various embodiments, when data is received at a time point, for example as shown in block 208, historical data recorded earlier, for example recorded since the first time point as shown in block 206, the second time as shown in block 207, or other time point prior to the first time point (not shown), are retrieved to assess and determine if Driver A’s performance in safe driving has improved. Based on the determination result, for example that the Driver A’s performance has improved over the time period since the retrieved historical data was first received, an optimal period, as indicated in block 204, to evaluate the Driver A’s performance in safe driving is determined.

Data relating to one or more risk variables received in various trips at various time point within this optimal period 204, for example as indicated in blocks 209 and 210, may be used to continually assess the performance of the Driver A 202 in safe driving. In an embodiment, when data is received at a time point amid the optimal period 204, as indicated in block 209, or at an end of the optimal period 204, as indicated in block 210, historical data recorded earlier, for example recorded since the first time point at block 206, since a time point within the optimal period at block 208, other time point prior to the first time point (not shown) or recorded during the most recent trips (e.g. 5 or 10 trips) made by the Driver A 202, are retrieved, and Driver’s A performance in safe driving is assessed and determined if his/her performance has improved. Based on the determination result, for example that the Driver A’s performance has improved or has not improved over the time period from a time point at which the retrieved historical data was first received to the time point amid the optimal period at block 209 (or to the end of the optimal period at block 210), a new optimal period extended or shortened from the previously calculated optimal period 204 may be determined and used for (re-)evaluating the Driver A’s performance in safe driving accordingly. Advantageously, the optimal period to evaluate Driver’s A performance in safe driving is adaptively derived and determined.

According to the present disclosure, optimal period for different drivers are not pre-determined. An optimal period for each driver is determined based on how the driver’s performance in safe driving improves over time, and different optimal periods may be determined for different drivers depending on the respective performances and improvements in their performances in safe driving. In an embodiment, different risk variables may also be used in assessing performances of different drivers.

In this embodiment, Driver B may not make any trip at a first time point, Data relating to the one or more risk variables of Driver B measured over a time period prior to the first time point (e.g. for the past few trips, days or months) may be retrieved and recorded, as indicated in block 226. The Driver B 222 may subsequently make a trip from location D to location E at a second time point, and one or more risk variables during the trip may be measured. Data relating to the one or more risk variables during the trip at the second time point, for example as indicated in block 227, may be received and recorded.

In this embodiment, based on the two data 226, 227, it may be determined that Driver B 222 has a performance in safe driving worse than Driver A or an average driver who practice safe driving, and may take a longer period to improve his driving performance to a desired performance. In other words, a longer period may be required to access and evaluate the performance of Driver B 222 than that of the Driver A 222. As a result, it is determined that the optimal period 224 for the Driver B 222 is longer than that of Driver B 224. Similarly, data relating to one or more risk variables received in various trips at various time point within this optimal period 224, for example as indicated in blocks 228 and 229, may be used to continually assess the performance of the Driver B 222 in safe driving. The optimal period 224 may also be adaptively derived and adjusted according to the result determined upon receipt of data 228, 229, for example when it is determined that the Driver B’s performance has improved or has not improved over the time period since the first time point 226 at which the retrieved historical data was first received to the time point amid the optimal period at block 228 (or to the end of the optimal period at block 229).

As opposed to the conventional method to determine a driver’s performance in safe driving using risk variables measure in each trip, it is noted that some risk variables that are used for determining if a driver’s performance in safe driving, for example number of harsh braking per trip over last 30 days, takes longer time than other risk variables to improve, and it cannot be improved overnight. Therefore, consistent safe driving effort is the key to accumulate improvement in such risk variables. The present disclosure provides a method for adaptively derive an optimal period or duration required to improve several such risk variables and different risk variables to achieve a desired performance and to monitor each individual driver.

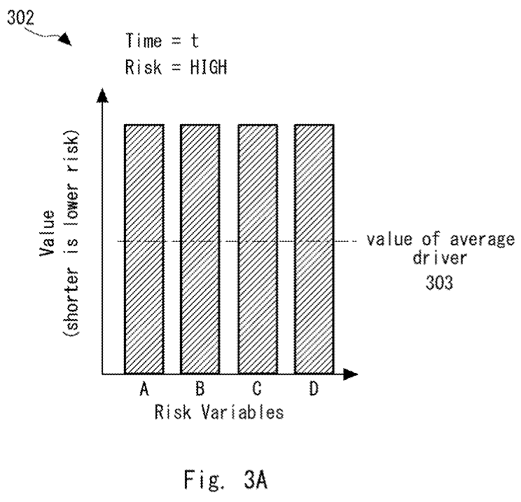

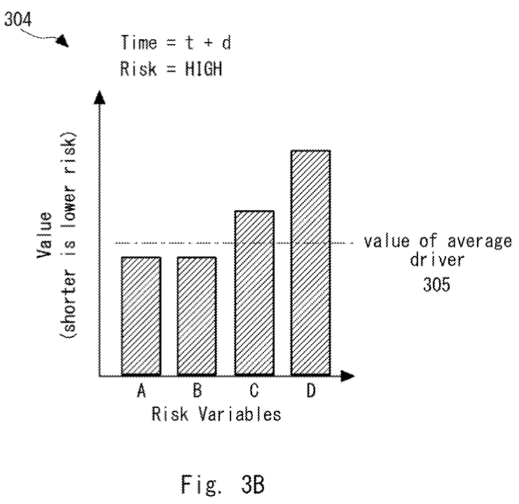

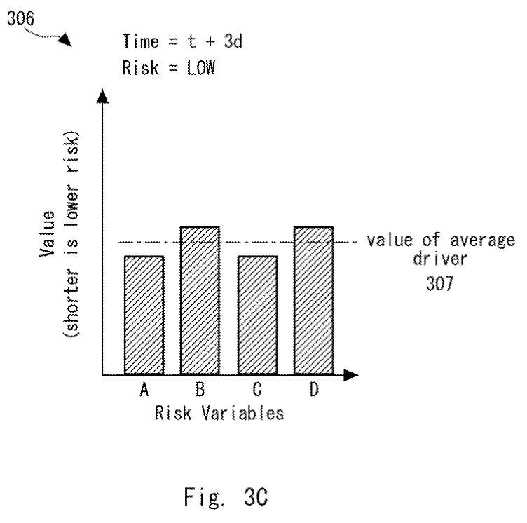

FIGS. 3A-3C show how an optimal period to evaluate a driver’s performance in safe driving is adaptively derived based on four risk variables, risk variables A, B, C and D, according to an embodiment of the present disclosure. This examples, risk variable A may relate to a count of speeding per kilometer driven over last 10 days; risk variable B may relate to a count of harsh braking per kilometer driven over last 10 days; variable C may relate to a number of harsh braking per trip over last 30 days; and variable D may relate to a count of driving complaints in last 12 months. Such assessment and derivation may be learned from historical data of the driver, an average driver, or both relating to the four risk variables A, B, C and D.

FIG. 3A shows a graph 302 illustrating a driver’s data relating to the four risk variables A, B, C, D received in a first time point t. At this first time point t, the driver may or may not make a trip. Data relating to the four risk variables A, B, C, D at this time point during the trip and/or over a time period (e.g. for the last few trips, days or months) are measured. The measured data relating to each of the four risk variables A, B, C, D show to have values higher than respective values of an average driver, as shown in dashed line 303. It is noted that in this example, a shorter (lower) value of the risk variable is associated with a lower risk in a driver’s performance. Hence, it is determined that the driver exhibits high risk in all risk variables A, B, C, D in his driving performance. This may indicate that the driver has not met the desired performance (below or close to the values of average driver) to be considered as safe driving.

In an embodiment, the solution provided in the present disclosure may recommend the driver to improve risk variables A and B as such variables typically can be improved in a short period of time, e.g. within a time period d, and recommend the driver to improve risk variables C, D within different time periods, e.g. longer than the time period d.

FIG. 3B shows a graph 304 illustrating a driver’s data relating to the four risk variables A, B, C, D received in a second time point t+d, i.e. a time period d after the first time point t. At this second time point t+d, the driver may make another trip. During this trip, data relating to the four risk variables A, B, C, D are again measured. It is determined that the data relating to the risk variables A, B have fallen to a value lower (better) than the value of an average driver, as shown in dashed line 305; the data relating to the risk variable C have fallen but with a value still higher (worse) than the value of an average driver; and the data relating to the risk variable D have also fallen only slightly and its value corresponds to high risk. As such, it is determined that the driver’s performance has improved but has not met the desired performance as the driver still exhibits a higher risk than an average driver, at least in term of risk variable D in his driving performance.

In an embodiment, the solution provided in the present disclosure may recommend the driver to further improve risk variables C and D within a period of time to lower the risk in his driving performance and meet the desired performance.

FIG. 3C shows a graph 306 illustrating a driver’s data (value) relating to the four risk variables A, B, C, D received in a third time point t+3d, i.e. a time period 3d after the first time point t. At this third time point t+3d, the driver may make another trip. During this trip, data relating to the four risk variables A, B, C, D are again measured. It is determined that the data relating to the risk variables A, B remains close to or better than the value of an average driver, as indicated in dashed line 307; while the data relating to the risk variables C, D have fallen to a value a similar level, that is, close to or better than the value of an average driver. As such, it is determined that the driver’s performance has further improved and meet the desired performance, and the driver exhibits a low risk in his driving performance.

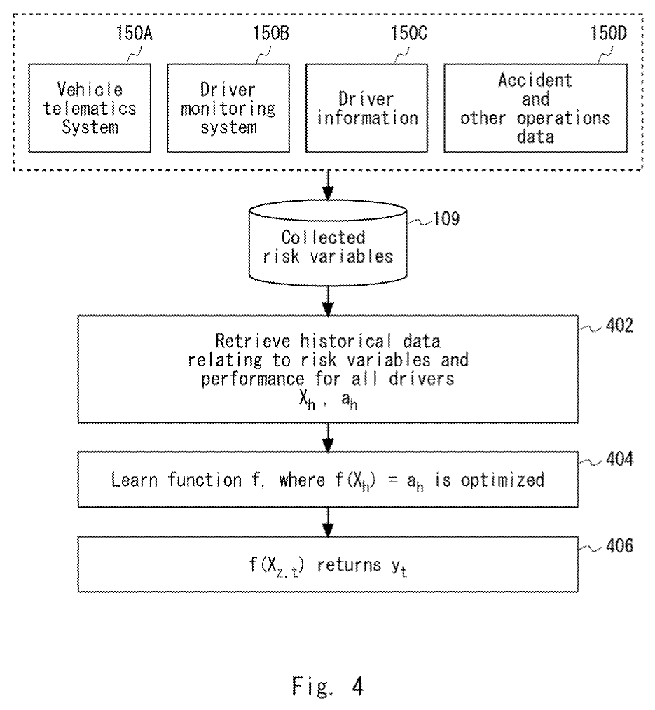

FIG. 4 depicts a flow chart illustrating a process 400 of adaptively deriving an optimal period to evaluate a driver’s performance in safe driving according to embodiments of the present disclosure. The process may start when data relating to at least one risk variables are received from servers such as Vehicles telematics system 150A, Driver monitoring system 150B, Driver information 150C and Accident and other operation data 150D. The received data may be collected and stored in a database 109. In step 402, historical data Xₕ relating to the at least one risk variable and number of accidents on records aₕ stored in the database 109 may be retrieved. In an embodiment, one or more preceding scores yₕ that were previously determined to rate the driver’s performances in safe driving based on the historical data may be stored in the database 109 and retrieved together with the historical data Xₕ correspondingly. Subsequently, in step 404, a learn function f is applied to assess the driver’s performance based on the received data and retrieved historical data, where f(Xₕ) = aₕ is optimized. In step 406, the learn function after the optimization f(X_{z,t}) then returns a driver’s performance score yₜ. In an embodiment, the learn function f or other function such as behaviours change function may be retrieved from servers or database 109 and apply in step 402. The assessment of the driver’s performance using the learn function f may then follow by determining if the driver’s performance in safe driving improves based on the newly determined score yₜ and determining an optimal period to continually evaluate and monitor the driver’s performance in safe driving.

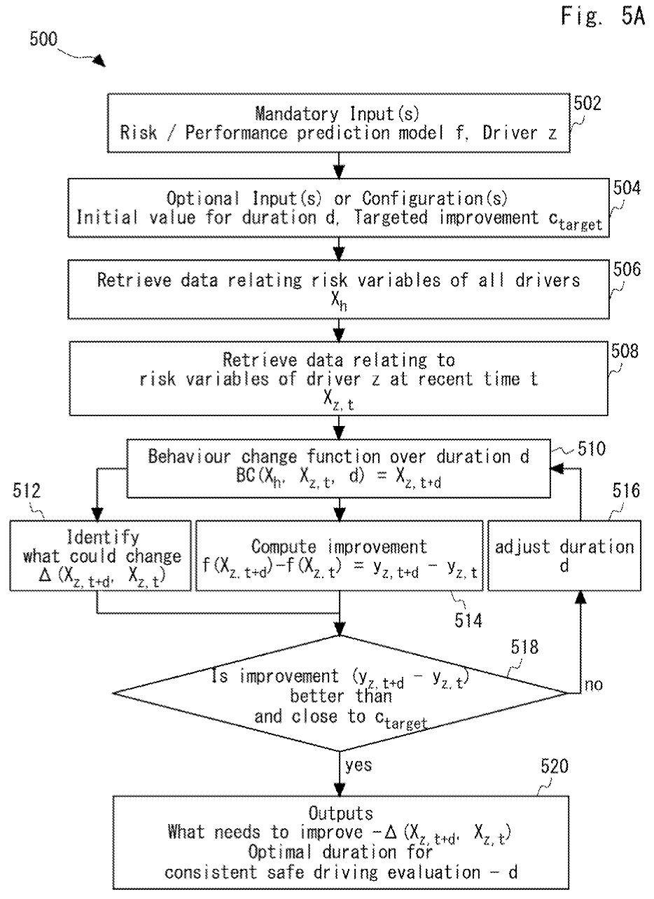

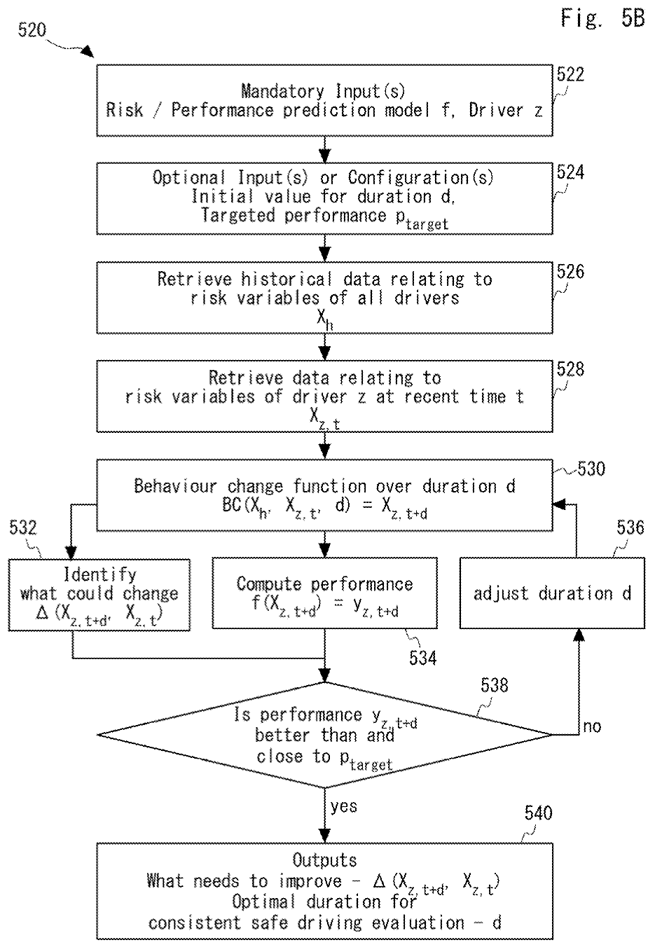

FIG. 5A depicts a flow chart 500 illustrating a process of adaptively deriving an optimal period to evaluate a driver’s performance in safe driving in greater details according to embodiments of the present disclosure. In step 502, a risk or performance prediction model f and a driver (user) z may be also be input or retrieved. Optionally, in step 504, parameters such as an initial value for duration (time period) d and a target improvement C_{target} to be achieved by the driver z may also be input or retrieved. In step 506, data relating to risk variables of all drivers whose driving performance have been evaluated may be retrieved from a database, which in various embodiments in the present disclosure, serves as a reference to determine data relating to the risk variables or general behaviour change and performance improvement relating to the risk variables achieved by all drivers in average.

In step 508, data relating to the at least one risk variables for the driver z at a recent time point t may be received and retrieved. In step 510, a behaviour change function over the input duration d may be applied to determine possible behaviour change and improvement of the driver z over the time period d. The step further includes a step of identifying what behaviour relating to the risk variables could change over the time period d, as illustrated in step 512, a step of computing a possible improvement of the driver’s performance in safe driving over the time period d, as illustrated in step 514. In step 518, it is determined if the computed improvement is better or close to the target improvement C_{target}. If so, step 520 is carried out; otherwise, step 516 is carried. In step 516, the time period d is adjusted accordingly, and in step 510, the behaviour change function is then carried out again using the adjusted time period d. In step 520, the time period d will then be determined as an optimal duration to evaluate and monitor the driver’s performance in safe driving and for the driver to meet the target performance C_{target} during this optimal duration d. An alert comprising the risk variables that require improvement and a personalized program with the corresponding behaviour to be carried out meet the target improvement C_{target} on the risk variables over the optimal duration d may also be output to the driver z.

FIG. 5B depicts a flow chart 520 illustrating another process of adaptively deriving an optimal period to evaluate a driver’s performance in safe driving in greater details according to embodiments of the present disclosure. In step 522, a risk or performance prediction model f and a driver (user) z may be also be input or retrieved. Optionally, in step 524, parameters such as an initial value for duration (time period) d and a target performance P_{target} to be achieved by the driver z may also be input or retrieved. In step 526, data relating to risk variables of all drivers whose driving performance have been evaluated may be retrieved from a database, which in various embodiments in the present disclosure, serves as a reference to determine data relating to the risk variables or general behaviour change and performance relating to the risk variables achieved by all drivers in average.

In step 528, data relating to the at least one risk variables for the driver z at a recent time point t may be received and retrieved. In step 530, a behaviour change function over the input duration d may be applied to determine possible behaviour change and performance of the driver z over the time period d. The step further includes a step of identifying what behaviour relating to the risk variables could change over the time period d, as illustrated in step 532, a step of computing a possible performance of the driver z in safe driving over the time period d, as illustrated in step 534. In step 538, it is determined if the computed improvement is better or close to the target performance P_{target}. If so, step 540 is carried out; otherwise, step 536 is carried. In step 536, the time period d is adjusted accordingly, and in step 530, the behaviour change function is then carried out again using the adjusted time period d. In step 540, the time period d will then be determined as an optimal duration to evaluate and monitor the driver’s performance in safe driving and for the driver to improve his/her performance in safe driving during this optimal duration d. An alert comprising the risk variables that require improvement and a personalized program with the corresponding behaviour to be carried out to meet the target performance P_{target} on the risk variables over the optimal duration d may also be output to the driver z.

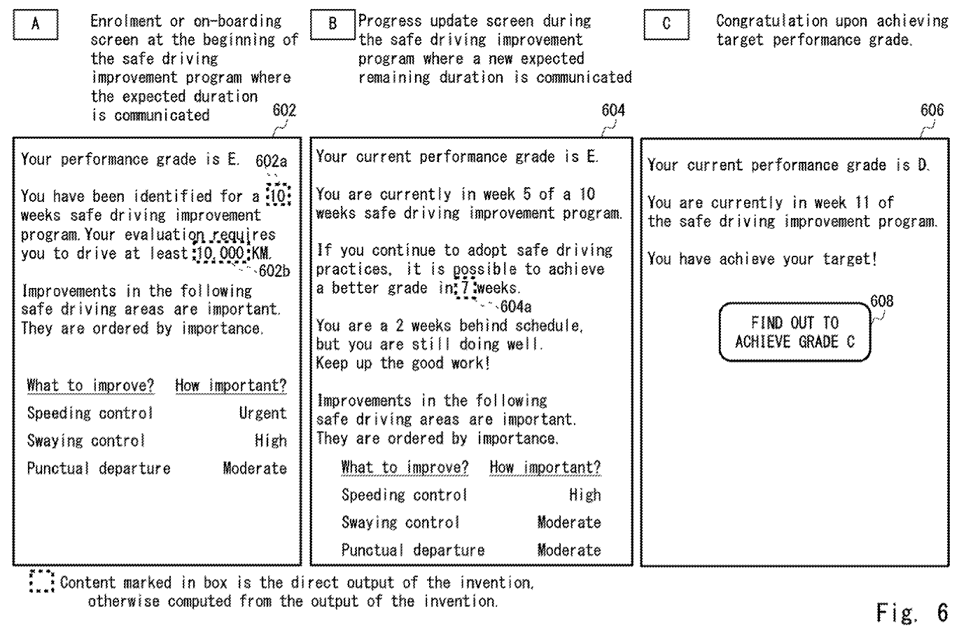

FIG. 6 show graphical user interface examples of how a program running an application for adaptively deriving an optimal period to evaluate a driver’s performance in safe driving from on-boarding to completion of the program according to an embodiment of the present disclosure.

In this embodiment, it may be determined that the driver has 42 records of driving above speed limit over last 10 days and 27 counts of swaying per km driven over last 100 km, and is 21 minute, in average, late from a scheduled departure time over last 30 days. Enrolment or on-boarding screen of the personalized safe improvement program as well as corresponding actions to be carried out in the program to meet the desired performance or improvement are communicated at the beginning of the personalized safe driving improvement program, as shown in screen A 602 of FIG. 6.

In particular, in screen A 602, the driver’s performance grade (score) of E, which was determined based on the risk variables, e.g. speeding control, swaying control, punctual departure, measured and the data and historical data relating to the risk variables collected, is presented. A font color (e.g. red) may be chosen for different performance grades and to indicate that the driver has failed to meet the desired performance in safe driving. The optimal period of 10000 kilometres (km) travel distance and an designated (or estimated) time period of 10 weeks required to increase the driver’s performance grade to “D” may be output from the computation process of FIG. 5, and presented in screen A, as indicated in 602b and 602a respectively.

The corresponding actions to be carried out to meet the desired improvement in the ten-week program may be determined and proposed to the driver and presented in an order of importance to the driver’s performance in safe driving. In this example, based on the difference in the driver’s performance to an average driver who practices safe driving as well as the impact of each risk variables to the driver’ safe driving performance, it is determined that the risk variables such as speeding control is of urgent importance, swaying control is of high importance and punctual departure is of low importance. In an embodiment, the order of the actions may be presented according to capabilities of the driver or an average driver in carrying out the actions and improving his driving performance to the target performance.

Screen B 604 presents an example screen of the application in the fifth week of the ten-week safe improvement program. By measuring data relating to the risk variables made by the driver since the start of the program or in recent trips, it may be determined that the driver’s performance in safe driving has improved, but the progress fall behind the expected schedule. The performance grade of the driver remain as the driver has not met the target improvement or achieve the target performance to be characterized under performance grade “D”.

It may also be determined using the behaviour change function that it is expected that the driver will only reach the target improvement or performance after another 7 weeks. As such, screen B 604 may present a text “if you continue to adopt safe driving practices, it is possible to achieve a better grade in 7 weeks”, as shown in 604a. An alert may be generated to notify the driver that his/her performance is two weeks behind the schedule based on the difference between the designated period and the timeline for the driver to reach the target performance, and require additional two weeks to achieve the target performance.

The corresponding actions to be carried out to meet the target performance or improvement in the ten-week program may be presented. In this example, based on the measured data relating to the risk variables in the recent trips against the driving performance of an average driver who practices safe driving, it is determined that the driver’s performance relating to the risk variables such as speeding control and swaying control have improved to a level of high importance and low importance respectively.

Screen C 606 presents an example screen of the application at 11^{th} week of the ten-week safe improvement program, i.e. after the 10-weeks program has ended. By measuring data relating to the risk variables since the start of the program or in recent trips, it is determined that the driver’s performance relating to all the risk variables have improved and meet the desired improvement under performance grade “D”. An alert may be generated to notify the driver that his/her latest performance grade is “D” and he/she has achieved the target at the 11^{th} week instead of the designated 10-weeks period. In an embodiment, the screen C 606 may include a link that directs the driver to a new personalized safe driving program to further improve his performance in safe driving from grade “D” to grade “C”, as shown in 608.

FIGS. 7A and 7B show other graphical user interface examples of how a program running an application for adaptively deriving an optimal period to evaluate a driver’s performance in safe driving from on-boarding to completion of the program according to an embodiment of the present disclosure. In particular, each of FIGS. 7A and 7B shows a simpler design of the user interface with more graphical representation used for presenting the same information relating to the safe driving program as opposed to that in FIG. 6.

For example, icons may be used to indicate the designated period (or distance) of the program, the target performance grade, the designated (estimated) time period such as the target number of week (or target date) to meet the desired performance or improvement in the program, the number of week since the start of the program (or today’s date) and the current performance grade of the driver, as indicated in 702a-702e, 704a-704e, 706a-706b, 712a-712e, 714a-714e and 716a-716b.

A circle may be used to track the remaining period of the designated period (or distance) of the program, as indicated in 702f, 704f, 712f and 714f, and the period completed by the driver from the designated period (or distance) of the program since the start of the program. In this embodiment, at the start of a program, an empty circle such as 702f, 712f is used to indicate the driver has not travelled or made any trip. As the driver travels more or make more trips, the circle will be filled up to the period (or distance) travelled and made correspondingly, as indicated using a filled arc like 704f′ and 714f′, while the empty arc like 704f, 714f indicates the remaining period to be travelled and made by the driver to complete the designated period of the program. When the circle is fully filled up, it may indicate that the driver has completed the designated period (or distance) and the program may end when the driver’s performance in safe driving is determined to have improved over the designated period. It should be appreciated by a skilled person that under different implementations and alterations of the embodiment, a filled circle may be used at the start of the program instead, and the fill of the circle is emptied corresponding to the period (or distance) completed or made by the driver.

Blocks or buttons are used as a notification to present the actions required to be carried out to meet the target performance or improvement in the program, as indicated in 702g-702i, 704g-704i, 712g-712i and 714g-714i. The simpler design and graphical representation of information using icons and blocks may assist the driver or the user of the application to better view the information and his/her progress in the program.

Similar to FIG. 6, in screen A 712 of FIG. 7A, enrolment or on-boarding screen of the personalized safe improvement program as well as corresponding actions to be carried out in the program to meet the desired performance or improvement are communicated at the beginning of the personalized safe driving improvement program. The driver’s performance score determined based on the risk variables measured and the data and historical data relating to the risk variables collected is presented in icon 702a and the target performance score is presented in icon 702d. The optimal period, i.e. the travel distance of 10000 km, and the designated time period of the program are presented in icons 702c and 702e respectively. The icon 702b indicating “week 1” representing this is the first week of the program.

The corresponding actions to be carried out to meet the desired improvement in this first week of the ten-week program are presented using three blocks (or buttons) 702g-702i which are arranged according to an order of importance level in screen A 702. A first block of the three blocks comprises a tag of “#Immediate&Urgent” which may be used to show any action that is of the utmost urgent importance and requires immediate attention, for example there are 42 records of driving above speed limit over last 500 km. In this case, it is determined that the risk variable relating to speeding control falls under this “Immediate&Urgent” category, as shown in block 702h. A second block of the three blocks comprises a tag of “SpendMoreEffort” which may be used to show any action that is of high importance and requires the driver to spend more effort on, for example there are 27 counts of swaying per km driven over last 5 days. In this case, it is determined that the risk variable swaying control falls under this “SpendMoreEffort” category, as shown in block 702h. A third block of the three blocks comprises a tag of “AlmostThere” which may be used to show any action that is of low importance and requires slightly more improvement to meet the desired performance, for example the driver is, in average, 21 minute late from a scheduled departure time over last 10 departures. In this case, it is determined that the risk variable relating to punctual departure falls under this “AlmostThere” category, as shown in block 702i. In an embodiment, the order of the actions may be presented according to capabilities of the driver or an average driver in carrying out the actions and improving his/her driving performance to meet the target performance.

Screen B 704 presents an example screen of the application in the fifth week of the ten-week program, as indicated in icon 704b. By measuring data relating to the risk variables made by the driver since the start of the program or in recent trips, it may be determined that the driver’s performance in safe driving has improved, but the progress fall behind the expected schedule. The performance grade of the driver remain as “E” as indicated in icon 704a, as the driver has not met the target improvement or achieve the target performance to be characterized under performance grade “D”.

In this embodiment, by evaluating how the driver’s performance has improved since the start of the program, and using the behaviour change function to estimate the driver progress, the estimation may suggest the driver to be monitored and evaluated for additional 1000 km, and hence a new optimal period of 11000 km travel distance may be determined, i.e. 1000 km up from the original optimal period of 10000 km travel distance, as indicated in block 704c. This in turn, determine that the driver may require two additional weeks than the initial 10-weeks period to achieve the target improvement and performance, as indicated in block 704e.

Screen B 704 also shows that the driver’s performances relating to speeding control and swaying control have improved over four weeks of the ten-weeks program, from the “#Immediate&Urgent” block 704g to “SpendMoreEffort” block 704h and from “SpendMoreEffort” block 704h to “AlmostThere” block 704i respectively.

Screen C 706 presents an example screen of the application at 11^{th} week of the ten-weeks safe improvement program, as indicated in icon 706b, while the driver’s current performance score is now grade “D”, as indicated in icon 706a. An alert may be generated to notify the driver that he/she has achieved the target at the 11^{th} week. In an embodiment, the screen C 706 may include a link that directs the driver to a new personalized safe driving program to further improve his performance score in safe driving from “D” to “C”, as shown in 708.

FIG. 7B shows similar graphical user interface examples of how a program running an application and presenting the information of safe driving program as that of FIG. 7A. The difference is the way of presenting the time or date of the program. In particular, as opposed to presenting the target (or expected) number of week to achieve the target improvement and the number of weeks since the start of the program, a target (or expected) date (as indicated in blocks 712e, 714e) and today’s date (as indicated in blocks 712b, 714, 716b) are presented instead.

In this example, at the start of the program on 11 May (as indicated in icon 712b), a target (or expected) date of 27 July (as indicated in icon 712e) for the driver achieve the target performance grade “D” (as indicated in icon 712a) is determined. However, on 15 June (as indicated in icon 714b), based on the progress of the driver, whether the driver’s performance in safe driving has improved or not, it may be determined that the driver may only be able to achieve the target improvement at another target (or expected) date, e.g. 10 August. As such, the original target date is strikethrough and the other target date is presented, as indicated in icon 714e.

In this example, in screen C 716, it is presented that the driver has a current performance score “D” (as indicated in icon 716a) on 3 August (as indicated in con 716b). An alert may be generated to notify the driver that he/she has achieved the target performance. In an embodiment, the screen C 716 may include a link that directs the driver to a new personalized safe driving program to further improve his performance in safe driving from grade from “D” to “C”, as shown in 718.

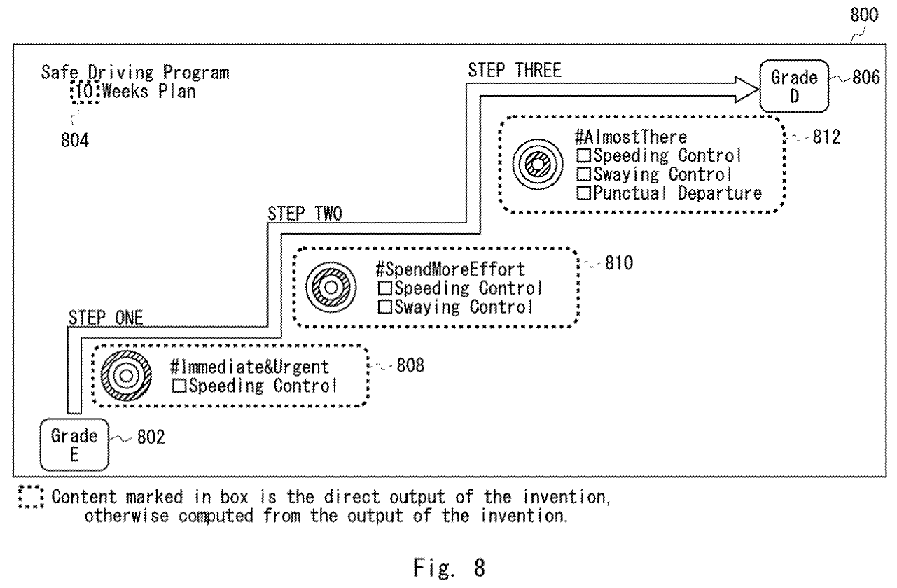

FIG. 8 depicts another graphical user interface example 800 of how a program running an application for adaptively deriving an optimal period to evaluate a driver’s performance in safe driving from on-boarding to completion of the program according to an embodiment of the present disclosure.

In this embodiment, it may be determined that the driver has 42 records of driving above speed limit over last 10 days and 27 counts of swaying per km driven over last 100 km, and is 21 minutes, in average, late from a scheduled departure time over last 30 days. Based on the difference in the driver’s performance to an average driver who practices safe driving, it is determined that the driver’s performance grade in safe driving is “E”, as shown in 802, and an optimal period of 10 weeks is required to improve the driver’s performance grade to “D”, as shown in fields 804, 806.

Based on the impact or importance of each risk variables to the driver’ safe driving performance, it is determined that the risk variable relating to speeding control is of urgent importance thus falls under “Immediate&Urgent” category; the risk variable relating to swaying control is of high importance thus falls under this “SpendMoreEffort” category; and the risk variable relating to punctual departure is of low importance thus falls under “AlmostThere” category.

A road map with three corresponding action steps to be carried out to meet the desired improvement of performance grade from “E” to “D” in a 10-weeks program are presented in the graphical user interface 800. In this embodiment, the steps are planned in accordance with an order of importance or impact to the driver’s performance in safe driving. In step one, the driver is prompted to work on risk variable that is tagged under “#Immediate&Urgent” category; in step two, to work on risk variables that is tagged under “#SpendMoreEffort” category; and in step three, to work on risk variable that is tagged under “#AlmostThere” category.

According to an embodiment, the program may be designed to improve risk variables that are of high impact or importance to the driver’ safe driving performance (tagged under “SpeedMoreEffort” and “#Immediate&Urgent” category) or of vast difference with those of an average driver who practices safe driving through two or three steps (stages) of the program, steps by steps, with each step (stage) having a target performance (performance checkpoint) incremented from the past performance of the driver in the previous step (stage), such that the driver’s performance of in safe driving improves progressively throughout the program. In an embodiment, the order of the actions in the program may be designed according to capabilities of the driver or an average driver in carrying out the actions and improving his/her driving performance to meet the target performance.

In step one, the driver is prompted to work on the risk variables which are tagged under “#Immediate&Urgent” category, e.g. speeding control (1^{st} stage) in this case, as indicated in block 808. For example, in the next few weeks, such risk variables may be constantly evaluated and monitored until the driver’s performance relating to each risk variable in the category has improved to a performance checkpoint (e.g. from 42 records to 36 records of driving above speed limit over last 10 days). The program will then move to step two.

In step two, the driver is prompted to work on the risk variables which are tagged under “#SpendMoreEffort” category, e.g. speeding control (2^{nd} stage) and swaying control (1^{st} stage) in this case, as indicated in block 810. Such risk variables may be constantly evaluated and monitored until the driver’s performance relating to each risk variable in the category has improved to a performance checkpoint (e.g. from 36 records to 29 records of driving above speed limit over last 10 days; and from 27 counts to 21 counts of swaying per km driven over last 100 km). The program will then move to step three.

In step three, the driver is prompted to work on the risk variables which are tagged under “#AlmostThere” category, e.g. speeding control (3^{rd} stage), swaying control (2^{nd} stage) and punctual departure in this case, as indicated in block 812. Such risk variables may be constantly evaluated and monitored until the driver’s performance relating to each risk variable has meet the target improvement or desired performance of the program, i.e. under performance grade D (e.g. from 29 records to 21 records of driving above speed limit over last 10 days; from 21 counts to 13 counts of swaying per km driven over last 100 km; and from 21 minutes to 15 minutes, in average, late from a scheduled departure time over last 30 days). The program may then end.

According to the present disclosure, in motor insurance model scenario, an insurance company can encourage drivers to aim for the next tier discount by challenging himself/herself to perform consistent safe driving evaluation. Advantageously, the insurance company are benefited from lesser claims while the driver is benefited from a lower insurance premium.

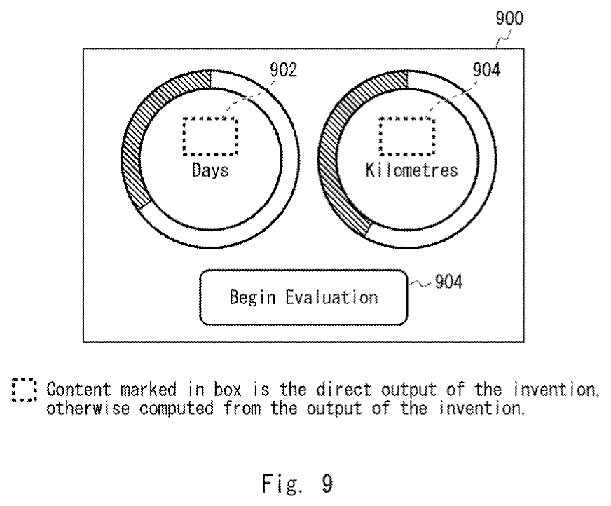

The present disclosure could help the insurance company to determine an optimal period, e.g. the evaluation duration, to evaluate the driver’s (user’s) performance in safe driving. The evaluation duration can be represented by a time period or a distance driven, where both time period and the distance driven vary across different drivers and are derived from the gap between the driver’s current performance and target performance. In an embodiment, both the time period and the distance driven must be met to ensure the driver is driving during the evaluation period such that the improvement of the driver’s performance in safe driving is properly determined. FIG. 9 depicts yet another graphical user interface example 900 of how a program running an application for adaptively deriving an optimal period to evaluate a driver’s performance in safe driving and showing result of derivation according to an embodiment of the present disclosure. Instead of the elaborated graphical user interfaces 602, 604, 606, 702, 704, 706, 712, 714, 716, 800 in FIGS. 6-8 used for tracking the progress of the driver, an insurance company may input evaluation period e.g. time period in days and the distance driven in km, into fields 902, 904 of the graphical user interface 900. The evaluation on the driver may start by clicking the “Begin Evaluation” button 904. The completion of the evaluation program of the driver is tracked. Upon completion of the evaluation program, the insurance may receive a notification, re-assess the driver’s performance and announce a reward to the driver or reject a reward request from the driver.

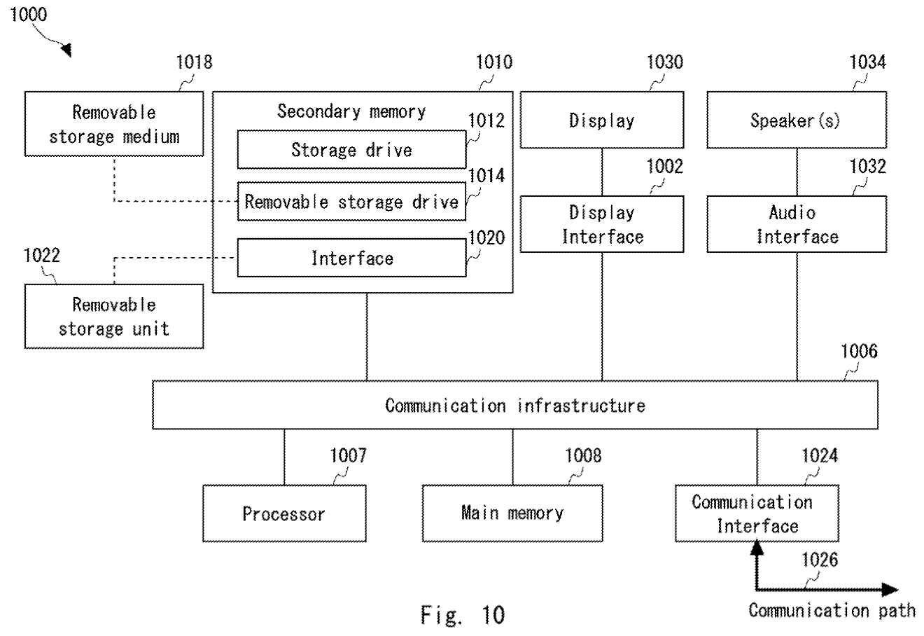

FIG. 10 shows an exemplary computing device 1000, hereinafter interchangeably referred to as a computer device 1000, where one or more such computing devices 1000 may be used to execute the methods 500, 520 of FIGS. 5A and 5B, respectively. The exemplary computing device 1000 can be used to implement the system 100 shown in FIG. 1. The following description of the computing device 1000 is provided by way of example only and is not intended to be limiting.

As shown in FIG. 10, the example computing device 1000 includes a processor 1007 for executing software routines. Although a single processor is shown for the sake of clarity, the computing device 1000 may also include a multi-processor system. The processor 1007 is connected to a communication infrastructure 1006 for communication with other components of the computing device 1000. The communication infrastructure 1006 may include, for example, a communications bus, cross-bar, or network.

The computing device 1000 further includes a main memory 1008, such as a random access memory (RAM), and a secondary memory 1010. The secondary memory 1010 may include, for example, a storage drive 1012, which may be a hard disk drive, a solid state drive or a hybrid drive and/or a removable storage drive 1014, which may include a magnetic tape drive, an optical disk drive, a solid state storage drive (such as a USB flash drive, a flash memory device, a solid state drive or a memory card), or the like. The removable storage drive 1014 reads from and/or writes to a removable storage medium 1018 in a well-known manner. The removable storage medium 1018 may include magnetic tape, optical disk, non-volatile memory storage medium, or the like, which is read by and written to by removable storage drive 1014. As will be appreciated by persons skilled in the relevant art(s), the removable storage medium 1018 includes a computer readable storage medium having stored therein computer executable program code instructions and/or data.

In an alternative implementation, the secondary memory 1010 may additionally or alternatively include other similar means for allowing computer programs or other instructions to be loaded into the computing device 1000. Such means can include, for example, a removable storage unit 1022 and an interface 1020. Examples of a removable storage unit 1022 and interface 1020 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1022 and interfaces 1020 which allow software and data to be transferred from the removable storage unit 1022 to the computer device 1000.

The computing device 1000 also includes at least one communication interface 1024. The communication interface 1024 allows software and data to be transferred between computing device 1000 and external devices via a communication path 1026. In various embodiments of the inventions, the communication interface 1024 permits data to be transferred between the computing device 1000 and a data communication network, such as a public data or private data communication network. The communication interface 1024 may be used to exchange data between different computing devices 1000 which such computing devices 1000 form part an interconnected computer network. Examples of a communication interface 1024 can include a modem, a network interface (such as an Ethernet card), a communication port (such as a serial, parallel, printer, GPIB, IEEE 1026, RJ45, USB), an antenna with associated circuitry and the like. The communication interface 1024 may be wired or may be wireless. Software and data transferred via the communication interface 1024 are in the form of signals which can be electronic, electromagnetic, and optical or other signals capable of being received by communication interface 1024. These signals are provided to the communication interface via the communication path 1026.

As shown in FIG. 10, the computing device 1000 further includes a display interface 1002 which performs operations for rendering images to an associated display 1030 and an audio interface 1032 for performing operations for playing audio content via associated speaker(s) 1034.

As used herein, the term “computer program product” may refer, in part, to removable storage medium 1018, removable storage unit 1022, a hard disk installed in storage drive 1012, or a carrier wave carrying software over communication path 1026 (wireless link or cable) to communication interface 1024. Computer readable storage media refers to any non-transitory, non-volatile tangible storage medium that provides recorded instructions and/or data to the computing device 1000 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1000. Examples of transitory or non-tangible computer readable transmission media that may also participate in the provision of software, application programs, instructions and/or data to the computing device 1000 include radio or infra-red transmission channels as well as a network connection to another computer or networked device, and the Internet or Intranets including e-mail transmissions and information recorded on Websites and the like.

The computer programs (also called computer program code) are stored in main memory 1008 and/or secondary memory 1010. Computer programs can also be received via the communication interface 1024. Such computer programs, when executed, enable the computing device 1000 to perform one or more features of embodiments discussed herein. In various embodiments, the computer programs, when executed, enable the processor 1007 to perform features of the above-described embodiments. Accordingly, such computer programs represent controllers of the computer device 1000.

Software may be stored in a computer program product and loaded into the computing device 1000 using the removable storage drive 1014, the storage drive 1012, or the interface 1020. The computer program product may be a non-transitory computer readable medium. Alternatively, the computer program product may be downloaded to the computer device 1000 over the communications path 1026. The software, when executed by the processor 1007, causes the computing device 1000 to perform the necessary operations to execute the method 500, 520 as shown in FIGS. 5A and 5B, respectively.

It is to be understood that the embodiment of FIG. 10 is presented merely by way of example to explain the operation and structure of the system 100. Therefore, in some embodiments one or more features of the computing device 1000 may be omitted. Also, in some embodiments, one or more features of the computing device 1000 may be combined together. Additionally, in some embodiments, one or more features of the computing device 1000 may be split into one or more component parts.

It will be appreciated by a person skilled in the art that numerous variations and/or modifications may be made to the present disclosure as shown in the specific embodiments without departing from the spirit or scope of the invention as broadly described. The present embodiments are, therefore, to be considered in all respects to be illustrative and not restrictive.

For example, the whole or part of the exemplary embodiments disclosed above can be described as, but not limited to, the following supplementary notes.

### (Supplementary Note 1)

A method for adaptively deriving an optimal period to evaluate a driver’s performance in safe driving, comprising:
receiving data relating to at least one risk variable which relates to the driver at a time point;
retrieving historical data relating to the at least one risk variable;
determining if the driver’s performance in safe driving improves based on the historical data and the data; and
determining the optimal period to evaluate the driver’s performance in safe driving in response to determining if the driver’s performance in safe driving improves.

### (Supplementary Note 2)

The method of Supplementary note 1, further comprising:

generating an alert based on the optimal period and the at least one risk variable.

### (Supplementary Note 3)

The method of any one of Supplementary notes 1 and 2, wherein determining if the driver’s performance in safe driving improves comprises:

determining a score based on the data and the historical data relating to the at least risk variable, the score corresponding to an overall performance of the driver’s performance in safe driving from a first time point at which the historical data was first received to the time point.

### (Supplementary Note 4)

The method of Supplementary note 3, wherein determining if the driver’s performance in safe driving improves comprises:

determining if the score is close to or better than a target value, the target value relating to a target improvement of the driver’s performance in safe driving to be achieved.

### (Supplementary Note 5)

The method of Supplementary note 4, wherein the target value is derived from at least one of an average score relating to performances of a plurality of drivers whose performance in safe driving has been evaluated, and a preceding score determined based on the historical data relating to the at least one risk variable, the preceding score corresponding to an overall performance of the driver’s performance in safe driving prior to the time point since the first time point.

### (Supplementary Note 6)

The method of any one of Supplementary notes 1-5, wherein the optimal period during which the driver’s performance in safe driving being evaluated relates to at least one of a time period, a mileage and a number of trips driven.

### (Supplementary Note 7)

The method of any one of Supplementary notes 1-6, wherein the step of retrieving historical data relating to the at least one risk variable comprising:

retrieving data relating to the at least one risk variable received over one or more time period from and one or more mileage driven before the time point.

### (Supplementary Note 8)

The method of any one of Supplementary notes 1-7, wherein the at least one risk variable comprises at least one of: (i) a count of speeding, swaying, sharp cornering, harsh acceleration and harsh braking per kilometre driven, (ii) a distance and a duration per day driven; and (iii) a count of driving complaints, customer service complaints and fault accidents.

### (Supplementary Note 9)

An apparatus for adaptively deriving an optimal period to evaluate a driver’s performance in safe driving, the apparatus comprising:
at least one processor; and
at least one memory including computer program code;
the at least one memory and the computer program configured to, with at least one processor, cause the apparatus at least to:
   receive data relating to at least one risk variable relating to the driver at a time point;
   retrieve historical data relating to the at least risk variable;
   determine if the driver’s performance in safe driving improves based on the historical data and the data; and
   determine the optimal period to evaluate the driver’s performance in safe driving in response to determining if the driver’s performance in safe driving improves.

### (Supplementary Note 10)

The apparatus according to Supplementary note 9, wherein the at least one memory and the computer program code are further configured, with at least one processor, cause the apparatus to:

generate an alert based on the optimal period and at least one risk variable.

### (Supplementary Note 11)

The apparatus according to any one of Supplementary notes 9 and 10, wherein the at least one memory and the computer program code are further configured, with at least one processor, cause the apparatus to:

determine a score based on the data and the historical data relating to the at least risk variable, the score corresponding to an overall performance of the driver’s performance in safe driving from a first time point at which the historical data was first received to the time point.

### (Supplementary Note 12)

The apparatus according to Supplementary note 11, wherein the at least one memory and the computer program code are further configured, with at least one processor, cause the apparatus to:

determine if the score is close to or better than a target value, the target value referring to a target improvement of the driver’s performance in safe driving to be achieved.

### (Supplementary Note 13)

The apparatus according to Supplementary note 12, wherein the target value is derived from at least one of an average value relating to performances of a plurality of drivers whose performance in safe driving has been evaluated, and a preceding score determined based on the historical data relating to the at least one risk variable, the preceding score corresponding to an overall performance of the driver’s performance in safe driving prior to the time point since the first time point.

### (Supplementary Note 14)

The apparatus of any one of Supplementary notes 9-13, wherein the optimal period during which the driver’s performance in safe driving being evaluated relates to at least one of a time period, a mileage and a number of trips driven.

### (Supplementary Note 15)

The apparatus according to any one of Supplementary notes 9-14, wherein the at least one memory and the computer program code is further configured, with at least one processor, cause the apparatus to:

retrieve data relating to the at least one risk variable received over one or more time period from and one or more mileage driven before the time point.

### (Supplementary Note 16)

The apparatus of any one of Supplementary notes 9-15, wherein the at least one risk variable comprises at least one of: (i) a count of speeding, swaying, sharp cornering, harsh acceleration and harsh braking per kilometre driven, (ii) a distance and a duration per day driven; and (iii) a count of driving complaints, customer service complaints and fault accidents.

### (Supplementary Note 17)

A vehicle for adaptively evaluating a driver’s performance in safe driving, comprising the apparatus as claimed in any one of Supplementary notes 9-16.

This application is based upon and claims the benefit of priority from Singapore Patent Application No. 10202009149Q, filed on Sep. 17, 2020, the disclosure of which is incorporated herein in its entirety by reference.

REFERENCE SIGNS LIST

| | |
|---|---|
| 100 | SYSTEM |
| 102 | REQUESTOR DEVICE |
| 108 | DRIVER’S SAFETY ASSESSMENT SERVER |
| 109 | DATABASE |
| 140 | REMOTE ASSISTANCE SERVER |
| 142A TO 142N | SENSORS |
| 150A TO 150N | REMOTE ASSISTANCE HOSTS |
| 1000 | COMPUTING DEVICE |
| 1002 | DISPLAY INTERFACE |
| 1006 | COMMUNICATION INFRASTRUCTURE |
| 1007 | PROCESSOR |
| 1008 | MAIN MEMORY |
| 1010 | SECONDARY MEMORY |
| 1012 | STORAGE DRIVE |
| 1014 | REMOVABLE STORAGE DRIVE |
| 1018 | REMOVABLE STORAGE MEDIUM |
| 1020 | INTERFACE |
| 1022 | REMOVABLE STORAGE UNIT |
| 1024 | COMMUNICATION INTERFACE |
| 1026 | COMMUNICATION PATH |
| 1030 | DISPLAY |
| 1032 | AUDIO INTERFACE |
| 1034 | SPEAKER(S) |

What is claimed is:

1. A method for adaptively deriving an optimal period to evaluate a driver’s performance in safe driving, comprising:
receiving data relating to at least one risk variable which relates to the driver at a time point;
retrieving historical data relating to the at least one risk variable;
determining if the driver’s performance in safe driving improves based on the historical data and the data; and
determining the optimal period to evaluate the driver’s performance in safe driving in response to determining if the driver’s performance in safe driving improves.

2. The method of claim 1, further comprising:
generating an alert based on the optimal period and the at least one risk variable.

3. The method of claim 1, wherein determining if the driver’s performance in safe driving improves comprises:
determining a score based on the data and the historical data relating to the at least risk variable, the score corresponding to an overall performance of the driver’s performance in safe driving from a first time point at which the historical data was first received to the time point.

4. The method of claim 3, wherein determining if the driver’s performance in safe driving improves comprises:
determining if the score is close to or better than a target value, the target value relating to a target improvement of the driver’s performance in safe driving to be achieved.

5. The method of claim 4, wherein the target value is derived from at least one of an average score relating to performances of a plurality of drivers whose performance in safe driving has been evaluated, and a preceding score determined based on the historical data relating to the at least one risk variable, the preceding score corresponding to an overall performance of the driver’s performance in safe driving prior to the time point since the first time point.

6. The method of claim 1, wherein the optimal period during which the driver’s performance in safe driving being evaluated relates to at least one of a time period, a mileage and a number of trips driven.

7. The method of claim 1, wherein the step of retrieving historical data relating to the at least one risk variable comprising:
retrieving data relating to the at least one risk variable received over one or more time period from and one or more mileage driven before the time point.

8. The method of claim 1, wherein the at least one risk variable comprises at least one of: (i) a count of speeding, swaying, sharp cornering, harsh acceleration and harsh braking per kilometre driven, (ii) a distance and a duration per day driven; and (iii) a count of driving complaints, customer service complaints and fault accidents.

9. An apparatus for adaptively deriving an optimal period to evaluate a driver’s performance in safe driving, the apparatus comprising:
at least one processor; and
at least one memory including computer program code;
the at least one memory and the computer program code configured to, with at least one processor, cause the apparatus at least to:
receive data relating to at least one risk variable relating to the driver at a time point;
retrieve historical data relating to the at least risk variable;
determine if the driver’s performance in safe driving improves based on the historical data and the data; and
determine the optimal period to evaluate the driver’s performance in safe driving in response to determining if the driver’s performance in safe driving improves.

10. The apparatus according to claim 9, wherein the at least one memory and the computer program code are further configured, with at least one processor, cause the apparatus to:
generate an alert based on the optimal period and at least one risk variable.

11. The apparatus according to claim 9, wherein the at least one memory and the computer program code are further configured, with at least one processor, cause the apparatus to:
determine a score based on the data and the historical data relating to the at least risk variable, the score corresponding to an overall performance of the driver’s performance in safe driving from a first time point at which the historical data was first received to the time point.

12. The apparatus according to claim 11, wherein the at least one memory and the computer program code are further configured, with at least one processor, cause the apparatus to:
determine if the score is close to or better than a target value, the target value referring to a target improvement of the driver’s performance in safe driving to be achieved.

13. The apparatus according to claim 12, wherein the target value is derived from at least one of an average value relating to performances of a plurality of drivers whose performance in safe driving has been evaluated, and a preceding score determined based on the historical data relating to the at least one risk variable, the preceding score corresponding to an overall performance of the driver’s performance in safe driving prior to the time point since the first time point.

14. The apparatus of claim 9, wherein the optimal period during which the driver’s performance in safe driving being evaluated relates to at least one of a time period, a mileage and a number of trips driven.

15. The apparatus according to claim 9, wherein the at least one memory and the computer program code is further configured, with at least one processor, cause the apparatus to:
retrieve data relating to the at least one risk variable received over one or more time period from and one or more mileage driven before the time point.

16. The apparatus of claim 9, wherein the at least one risk variable comprises at least one of: (i) a count of speeding, swaying, sharp cornering, harsh acceleration and harsh braking per kilometre driven, (ii) a distance and a duration per day driven; and (iii) a count of driving complaints, customer service complaints and fault accidents.

17. A vehicle for adaptively evaluating a driver’s performance in safe driving, comprising the apparatus as claimed in claim 9.
